(19) United States
(12) Patent Application Publication
(10) Pub. No.: US 2004/0203445 A1
(43) Pub. Date: Oct. 14, 2004

(54) Apparatus and method for up-link data communication

(76) Inventor: Chan-soo Hwang, Yongin-city (KR)

Correspondence Address: LEE & STERBA, P.C., Suite 2000, 1101 Wilson Boulevard, Arlington, VA, 22209, US

(21) Appl. No.: 10/383,658

(22) Filed: Mar. 10, 2003

(30) Foreign Application Priority Data
Mar. 30, 2002 (KR) 2002-17605

(51) Int. Cl. H04B 17/00

(52) U.S. Cl. 455/67.11; 455/67.13

(57) ABSTRACT

An apparatus and method for up-link data communication that obtains user information from wireless signals transmitted from b mobile stations (b>1) among a mobile stations (a>2), each mobile station having an antenna includes c antennas (where c≧a) for receiving the wireless signal, a multi-channel receiving unit for extracting received signals from the wireless signal received by the c antennas, a channel value estimating unit for estimating impulse responses of channels that are formed between the mobile stations and the antennas, from the received signals and outputs the estimated impulse responses as channel values, and a information estimating unit for canceling interference between the mobile stations, from the received signal and the channel values, and estimates the user information from the result of the cancellation.

### BACKGROUND OF THE INVENTION

1. Field of the Invention

The present invention relates to wireless communication. More particularly, the present invention relates to an apparatus and method for up-link data communication, which is data communication from mobile stations to a base station in wireless communication.

2. Description of the Related Art

In general, in a first conventional method for up-link data communication, a multiple antenna is simultaneously required in a base station and a subscriber station, which may be a mobile station. However, since the size of a mobile subscriber station is limited, the first conventional method for up-link data communication is not able to provide a multiple antenna for the subscriber station.

In a second conventional method for up-link data communication, a wireless signal received from a subscriber is discriminated by increasing the number of sectoring. However, sectoring having only a small beam width should be used in the second conventional method for up-link data communication. Thus, the second conventional method for up-link data communication is not able to be used when scattering of a channel is severe.

### SUMMARY OF THE INVENTION

In an effort to solve the above problems, it is a first feature of an embodiment of the present invention to provide an apparatus for up-link data communication that is capable of reducing a random access period and increasing the capacity of a channel by the number of antennas of a base station in data communication from a mobile station to the base station.

It is a second feature of an embodiment of the present invention to provide a method for up-link data communication that is capable of reducing a random access period and increasing the capacity of a channel by the number of antennas of a base station in data communication from a mobile station to the base station.

Accordingly, to provide the first feature, according to one aspect of the present invention, there is provided an apparatus for up-link data communication that obtains user information from a wireless signal transmitted from b mobile stations (where b is a positive integer greater than one (1)) among a mobile stations (where a is a positive integer greater than two (2)), each mobile station having an antenna including c antennas (where c≧a) for receiving the wireless signal, a multi-channel receiving unit for extracting a received signal from the wireless signal received by the c antennas, a channel value estimating unit for estimating impulse responses of channels that are formed between the mobile stations and the antennas, from the received signal and for outputting the estimated impulse responses as channel values, and an information estimating unit for canceling interference between the mobile stations, from the received signals and the channel values, and for estimating the user information from the result of the cancellation.

To provide the second feature, according to another aspect of the present invention, there is provided a method for up-link data communication performed by the previously-described apparatus for up-link data communication including receiving the wireless signal and extracting the received signal from the received wireless signal, estimating the impulse responses using the received signal and determining the estimated impulse responses as the channel values, and canceling the interference using the received signal and the channel values and estimating the user information using the result of the cancellation.

To provide the first feature, according to another aspect of the present invention, there is provided An apparatus for up-link data communication that obtains user information from a wireless signal transmitted from b mobile stations (where b is a positive integer greater than one (1)) among a mobile stations (where a is a positive integer greater than two (2)), each mobile station having an antenna, including c antennas (where c≧a) for receiving the wireless signal; a multi-channel receiving unit for extracting a received signal from the wireless signal received by the c antennas; a channel value estimating unit for estimating impulse responses of channels that are formed between the mobile stations and the antennas, from the received signals and for outputting the estimated impulse responses as channel values; a first information estimating unit, which is enabled in response to a first control signal, for canceling interference between the mobile stations from the received signals and the channel values, and for estimating the user information from the result of the cancellation; a second information estimating unit, which is enabled in response to a second control signal, for combining the received signals using the channel values, and for estimating the user information from the result of the combination; and an enabling unit for generating the first and second control signals at a predetermined time interval.

To provide the second feature, according to another aspect of the present invention, there is provided a method for up-link data communication performed by the previous apparatus for up-link data communication, including receiving the wireless signal and extracting the received signal from the received wireless signal; estimating the impulse responses using the received signal and determining the estimated impulse responses as the channel values; determining whether a communication time belongs to a random access period; canceling the interference using the received signal and the channel values and estimating the user information using the result of the cancellation, if it is determined that the communication time belongs to the random access period; and combining the received signals using the channel values and estimating the user information using the result of the combination, if it is determined that the communication time does not belong to the random access period.

To provide the first feature, according to yet another aspect of the present invention, there is provided an apparatus for up-link data communication that obtains user information from a wireless signal transmitted from b mobile stations (where b is a positive integer greater than one (1)) among a mobile stations (where a is a positive integer greater than two (2)), each mobile station having an antenna, including a first up-link data communication unit, which is enabled in response to a first control signal, for estimating channel values from received signals extracted from the received wireless signal, for canceling interference between the mobile stations from the estimated channel values and the received signals, and for estimating the user information from the result of the cancellation; a second up-link data communication unit, which is enabled in response to a second control signal, for estimating channel values from received signals extracted from the received wireless signal, for combining the received signals using the estimated channel values, and for estimating the user information from the result of the combination; and an enabling unit for generating the first and second control signals at a predetermined time interval, wherein each of the first and second up-link data communication units has c antennas (where c≧a) for receiving the wireless signal, and the channel values correspond to impulse responses of channels that are formed between the mobile stations and the antennas.

Preferably, the first up-link data communication unit includes a first multi-channel receiving unit for extracting the received signals from the wireless signal received by the c antennas; a first channel value estimating unit for estimating the channel values from the signals received from the first multi-channel receiving unit; and a first information estimating unit for canceling the interference from the signals received from the first multi-channel receiving unit and the channel values received from the first channel value estimating unit, and for estimating the user information from the result of the cancellation, wherein at least one of the first multi-channel receiving unit, the first channel value estimating unit, and the first information estimating unit is enabled in response to the first control signal.

Preferably, the second up-link data communication unit includes a second multi-channel receiving unit for extracting the received signals from the wireless signal received by the c antennas; a second channel value estimating unit for estimating the channel values from the signals received from the second multi-channel receiving unit; and a second information estimating unit for combining the signals received from the second multi-channel receiving unit using the channel values received from the second channel value estimating unit, and for estimating the user information from the result of the combination, wherein at least one of the second multi-channel receiving unit, the second channel value estimating unit, and the second information estimating unit is enabled in response to the second control signal.

### BRIEF DESCRIPTION OF THE DRAWINGS

The above features and advantages of the present invention will become more apparent to those of ordinary skill in the art by describing in detail preferred embodiments thereof with reference to the attached drawings in which:

FIG. 1 illustrates an external environment of an apparatus for up-link data communication according to an embodiment of the present invention;

FIG. 2 is a block diagram illustrating a preferred embodiment of the apparatus for up-link data communication shown in FIG. 1;

FIG. 3 is a flow chart illustrating an embodiment of a method for up-link data communication implemented using the apparatus for up-link data communication shown in FIG. 2;

FIG. 4 is a flow chart illustrating another embodiment of the method for up-link data communication according to the present invention;

FIG. 5 is a block diagram illustrating another preferred embodiment of the apparatus for up-link data communication shown in FIG. 1, which implements the method for up-link data communication shown in FIG. 4;

FIG. 6 is a block diagram illustrating yet another preferred embodiment of the apparatus for up-link data communication shown in FIG. 1, which implements the method for up-link data communication shown in FIG. 4;

FIG. 7 illustrates the concept of random access in a conventional slotted ALOHA manner according to the prior art;

FIG. 8 illustrates the concept of random access in a slotted ALOHA manner according to an embodiment of the present invention;

FIG. 9 is a conceptual diagram for modeling a channel; and

FIG. 10 is a graph for comparing the performance of the present invention with that of prior art.

### DETAILED DESCRIPTION OF THE INVENTION

Korean Patent Application No. 2002-17605, filed on Mar. 30, 2002, and entitled: “Apparatus and Method for Up-Link Data Communication,” is incorporated by reference herein in its entirety.

Hereinafter, both the structure and the operation of preferred embodiments of an apparatus for up-link data communication and a method for up-link data communication of each embodiment, according to the present invention, will be described in detail with reference to the accompanying drawings.

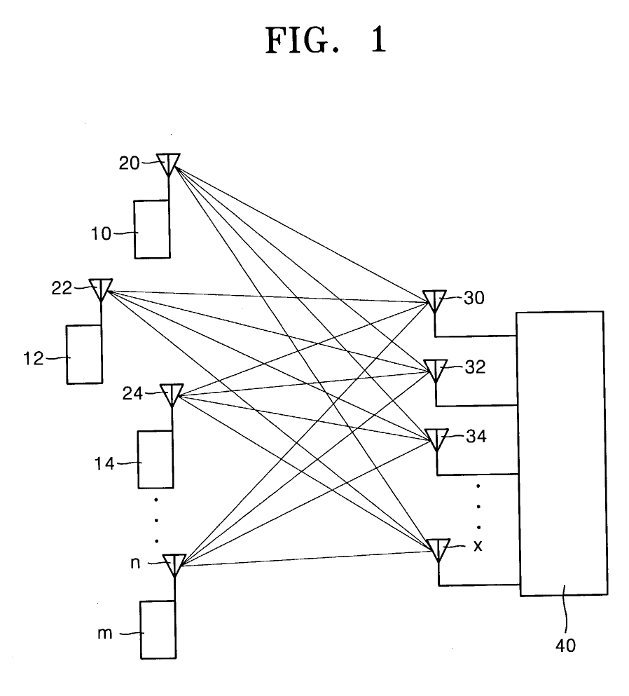

FIG. 1 illustrates an external environment of an apparatus for up-link data communication according to an embodiment of the present invention. Referring to FIG. 1, the external environment of the apparatus for up-link data communication according to the present invention includes a mobile stations 10, 12, 14, . . . , m (where a is a positive integer greater than two (2)) and a base station 40. Here, the base station 40 corresponds to the apparatus for up-link data communication according to the present invention.

Each mobile station 10, 12, 14, . . . , or m, as shown in FIG. 1, has only one antenna 20, 22, 24, . . . , or n, and b mobile stations (where b is a positive integer greater than one (1)) among the a mobile stations 10, 12, 14, . . . , and m transmit a wireless signal to the base station 40 via a multiple or single carrier wave while using same resources, such as time, frequency, or code. For this purpose, the base station 40 has c antennas 30, 32, 34, . . . , and x (where c≧a) for receiving the wireless signal. Up-link data communication from the mobile station 10, 12, 14, . . . , or m to the base station 40 according to an embodiment of the present invention will now be described.

FIG. 2 is a block diagram illustrating a preferred embodiment (40A) of the apparatus 40 for up-link data communication shown in FIG. 1. Referring to FIG. 2, the apparatus 40A for up-link data communication includes an antenna terminal 60 comprised of c antennas 62, 64, 66, . . . , and y, a multi-channel receiving unit 80, a channel value estimating unit 82, and a information estimating unit 84.

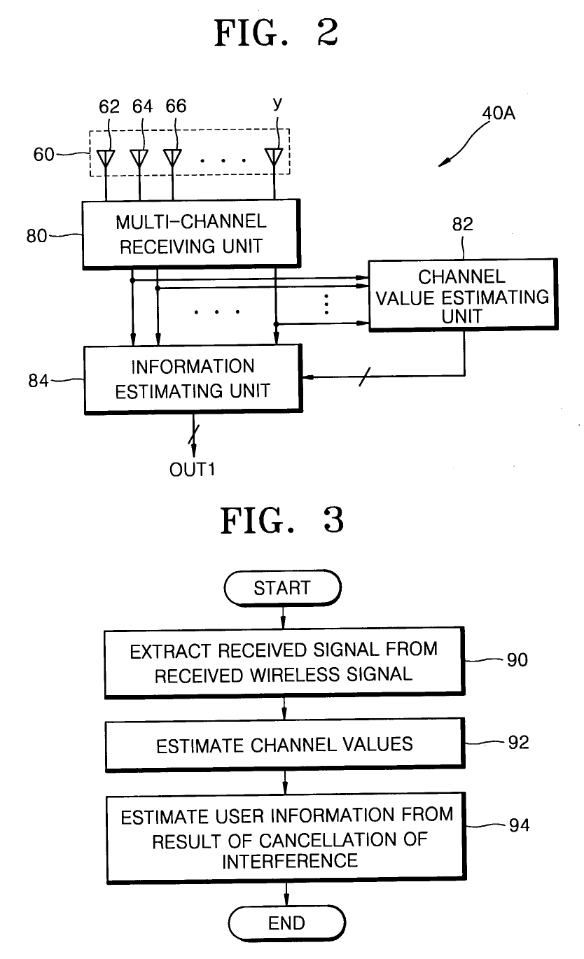

FIG. 3 is a flow chart illustrating an embodiment of a method for up-link data communication implemented with the apparatus 40A for up-link data communication shown in FIG. 2. The method shown in FIG. 3 includes steps 90 and 92 of estimating channel values using a received signal that is extracted from a wireless signal, and step 94 of estimating user information.

In the method for up-link data communication according to an embodiment of the present invention, in step 90, a wireless signal transmitted from the b mobile stations among the a mobile stations 10, 12, 14, . . . , and m is received, and a received signal is extracted from the received wireless signal. For this purpose, the c antennas 62, 64, 66, . . . , and y included in the antenna terminal 60 receive a wireless signal, and the multi-channel receiving unit 80 extracts a received signal from the wireless signal received via the c antennas 62, 64, 66, . . . , and y, and outputs the extracted received signal to the channel value estimating unit 82 and the information estimating unit 84.

After step 90, in step 92, impulse responses are estimated using estimated received signals, and the estimated impulse responses are determined as estimated channel values. For this purpose, the channel value estimating unit 82 estimates the impulse responses of channels that are formed between the a mobile stations 10, 12, 14, . . . , and m and the c antennas 62, 64, 66, . . . , and y, from the received signals and outputs the estimated impulse responses as the estimated channel values to the information estimating unit 84.

After step 92, in step 94, interference between the mobile stations 10, 12, 14, . . . , and m, that is, interference between symbols, is cancelled using the received signal and the channel values, and user information is estimated using the result of the cancellation. Techniques such as zero forcing, minimum mean square error (MMSE), or interference cancellation, may be used to cancel this interference. Here, in the zero forcing technique, interference is cancelled by multiplying a reverse of an estimated channel value by a received signal, but noise is increased. The MMSE and interference cancellation technique used to solve this problem are disclosed in the articles “Layered Space Time Architecture for Wireless Communication in a Fading Environment when Using Multi Element Antennas,” G. J. Foschini, Bell Labs Technical Journal, pp.41-59, Autumn 1996, and “Power Allocation Strategies for Wireless Systems with Multiple Transmit Antennas,” by D. Shiu and J. M. Kahn, IEEE Transactions on Communications, June 1998, respectively.

In order to perform step 94, the information estimating unit 84 cancels interference between the mobile stations 10, 12, 14, . . . , and m from a signal received from the multi-channel receiving unit 80 and the channel values received from the channel value estimating unit 82, estimates user information from the result of the cancellation, and outputs the estimated user information to an output terminal OUT1, i.e., a network.

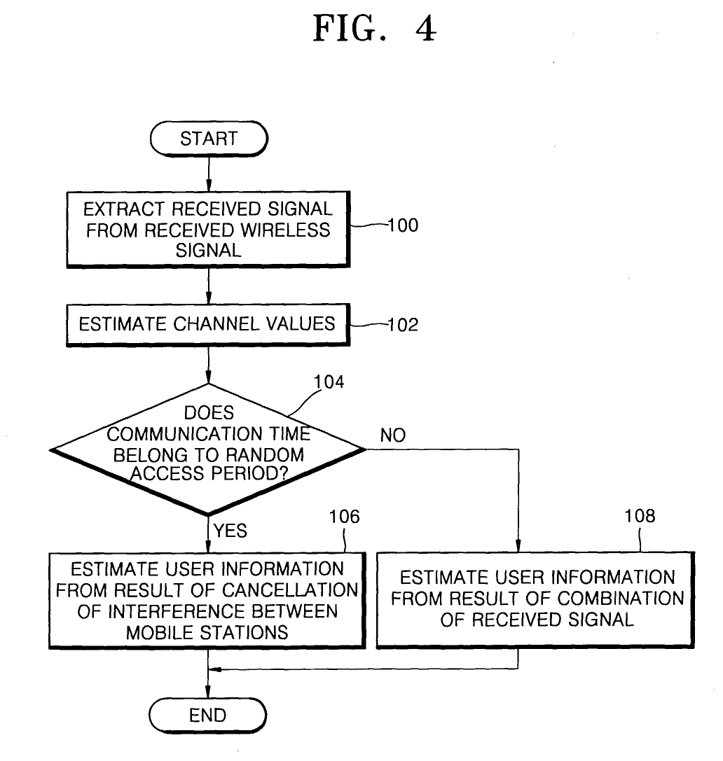

FIG. 4 is a flow chart illustrating another embodiment of a method for up-link data communication according to the present invention. The method shown in FIG. 4 includes steps 100 and 102 of estimating channel values using a received signal that is extracted from a wireless signal, and steps 104 through 108 of estimating user information depending on whether a communication time belongs to a random access period (RAP).

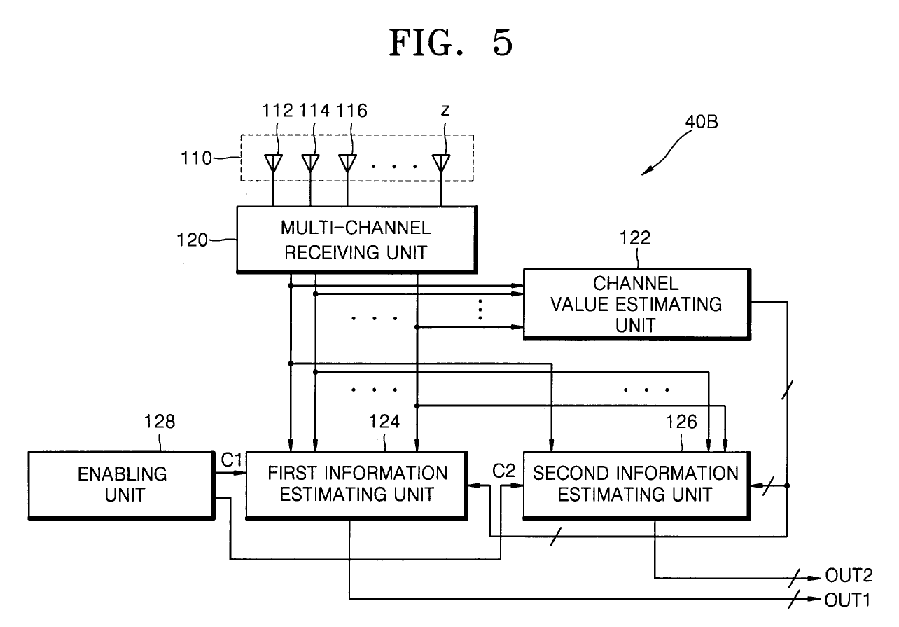

FIG. 5 is a block diagram illustrating another preferred embodiment (40B) of the apparatus 40 for up-link data communication shown in FIG. 1, which implements the method for up-link data communication shown in FIG. 4. Referring to FIG. 5, the apparatus 40B for up-link data communication includes an antenna terminal 110 comprised of c antennas 112, 114, 116, . . . , and z, a multi-channel receiving unit 120, a channel value estimating unit 122, first and second information estimating units 124 and 126, and an enabling unit 128.

In the method for up-link data communication according to the second preferred embodiment of the present invention, in step 100, a wireless signal transmitted from a mobile station is received, and a received signal is extracted from the received wireless signal. For this purpose, the c antennas 112, 114, 116, . . . , and z included in the antenna terminal 110 receive a wireless signal, and the multi-channel receiving unit 120 extracts a received signal from the wireless signal that is received via the c antennas 112, 114, 116, . . . , and z.

After step 100, in step 102, impulse responses of channels that are formed between the mobile stations 10, 12, 14, . . . , and m and the antennas 112, 114, 116, . . . , and z, are estimated using received signals, and the estimated impulse responses are determined as estimated channel values. For this purpose, the channel value estimating unit 122 estimates the impulse responses of the channels that are formed between the mobile stations 10, 12, 14, . . . , and m and the antennas 112, 114, 116, . . . , and z from the signals received from the multi-channel receiving unit 120, and outputs the estimated impulse responses as the estimated channel values to the first and second information estimating units 124 and 126, respectively.

After step 102, in step 104, it is determined whether a communication time belongs to a random access period. Here, in the state where resources for communication of the base station with the mobile station are not allocated to the base station and the mobile station, the random access period means a period during which a mobile station transmits control information to a base station at an arbitrary time for allocation of the resources.

For this purpose, the enabling unit 128 outputs first and second control signals C1 and C2 generated at a predetermined time interval to the first and second information estimating units 124 and 126, respectively, and selectively operates the first and second information estimating units 124 and 126 individually. For example, when the communication time belongs to the random access period, the first information estimating unit 124 is enabled in response to the first control signal C1 generated by the enabling unit 128, and when the communication time does not belong to the random access period, the second information estimating unit 126 is enabled in response to the second control signal C2 generated by the enabling unit 128.

If, in step 104, it is determined that the communication time belongs to the random access period, in step 106, interference between the mobile stations 10, 12, 14, . . . , and m is cancelled using the received signal and the channel values, and user information is estimated using the result of the cancellation. For this purpose, if it is recognized that the communication time belongs to the random access period through the first control signal C1 received from the enabling unit 128, the first information estimating unit 124 cancels interference between the mobile stations 10, 12, 14, . . . , and m from the signal received from the multi-channel receiving unit 120 and the channel values received from the channel value estimating unit 122, estimates user information from the result of cancellation, and outputs the estimated user information to an output terminal OUT1, i.e., a network.

However, if, in step 104, it is determined that the communication time does not belong to the random access period, in step 108, the received signal is combined using the channel values, and user information is estimated using the result of the combination. For this purpose, if it is recognized that the communication time does not belong to the random access period through the second control signal C2, the second information estimating unit 126 combines the signal received from the multi-channel receiving unit 120 using the estimated channel values received from the channel value estimating unit 122, estimates user information from the result of the combination, and outputs the estimated user information to an output terminal OUT2, i.e., a network.

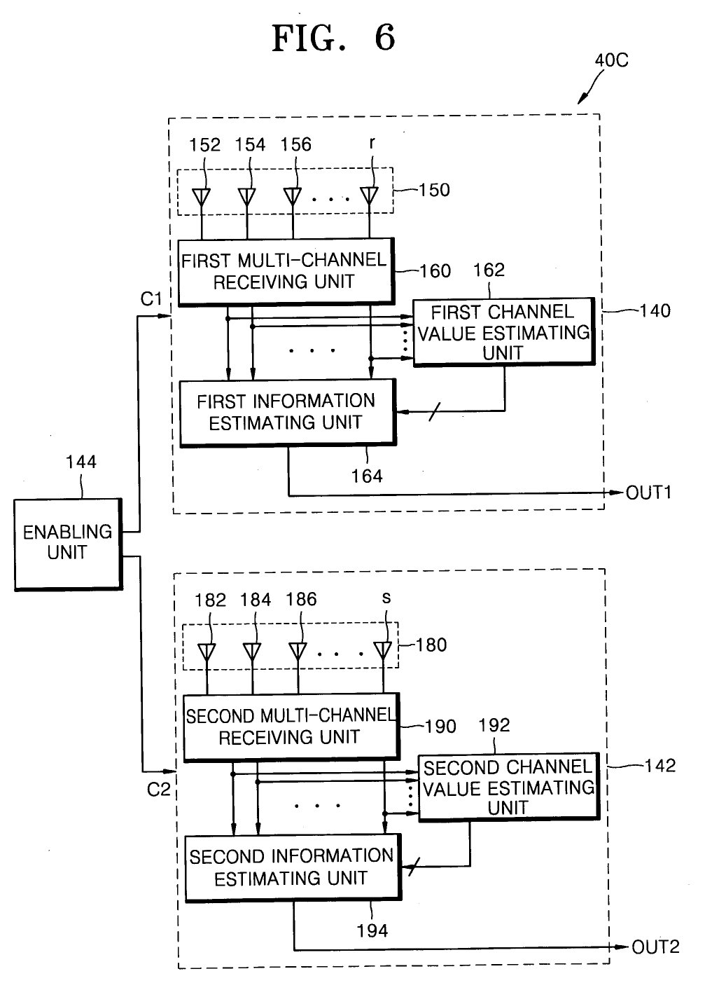

FIG. 6 is a block diagram illustrating another preferred embodiment (40C) of the apparatus 40 for up-link data communication shown in FIG. 1 according to the present invention, which implements the method for up-link data communication shown in FIG. 4. The apparatus 40C for up-link data communication includes a first and a second up-link data communication unit 140 and 142, respectively, and an enabling unit 144.

According to the third preferred embodiment of the present invention, in order to perform steps 100, 102, and 106 of FIG. 4, the first up-link data communication unit 140 shown in FIG. 6 is enabled in response to a first control signal C1 received from the enabling unit 144, estimates channel values from a received signal extracted from a received wireless signal, cancels interference between the mobile stations 10, 12, 14, . . . , and m from the estimated channel values and received signals, and estimates user information from the result of the cancellation. For this purpose, the first up-link data communication unit 140 may be implemented with an antenna terminal 150 having c antennas 152, 154, 156, . . . , and r, a first multi-channel receiving unit 160, a first channel value estimating unit 162, and a first information estimating unit 164.

In step 100, the c antennas 152, 154, 156, . . . , and r included in the antenna terminal 150 receive a wireless signal, and the first multi-channel receiving unit 160 extracts a received signal from the wireless signal received by the c antennas 152, 154, 156, . . . , and rand outputs the extracted received signal to the first channel value estimating unit 162 and the first information estimating unit 164.

In step 102, the first channel value estimating unit 162 estimates channel values corresponding to impulse responses of channels that are formed between the mobile stations 10, 12, 14, . . . , and m and the antennas 152, 154, 156, . . . , and r, from signals received from the first multi-channel receiving unit 160 and outputs the estimated channel values to the first information estimating unit 164.

In this case, in step 106, the first information estimating unit 164 cancels interference between the mobile stations 10, 12, 14, . . . , and m from a signal received from the first multi-channel receiving unit 160 and estimated channel values received from the first channel value estimating unit 162, estimates user information from the result of the cancellation, and outputs the estimated user information to an output terminal OUT1, i.e., a network. The first information estimating unit 164 performs the same operation as that of the first information estimating unit 124 shown in FIG. 5.

In this case, at least one of the first multi-channel receiving unit 160, the first channel value estimating unit 162, and the first information estimating unit 164 is enabled in response to the first control signal C1 output from the enabling unit 144 so that the first up-link data communication unit 140 performs steps 100, 102, and 106 only when it is recognized that the communication time belongs to the random access period.

Meanwhile, in order to perform steps 100, 102, and 108 of FIG. 4, the second up-link data communication unit 142 of FIG. 6 is enabled in response to the second control signal C2 received from the enabling unit 144, estimates channel values from a received signal that is extracted from a received wireless signal, estimates user information from the result of combination of received signals using the estimated channel values, and outputs the estimated user information to an output terminal OUT2, i.e., a network. For this purpose, the second up-link data communication unit 142 may be implemented with an antenna terminal 180 having c antennas 182, 184, 186, . . . , and s, a second multi-channel receiving unit 190, a second channel value estimating unit 192, and a second information estimating unit 194.

In step 100, the c antennas 182, 184, 186, . . . , and s included in the antenna terminal 180 receive a wireless signal, and the second multi-channel receiving unit 190 extracts a received signal from the wireless signal received by the c antennas 182, 184, 186, . . . , and s and outputs the extracted received signal to the second channel value estimating unit 192 and the second information estimating units 194.

In step 102, the second channel value estimating unit 192 estimates channel values corresponding to impulse responses of channels that are formed between the mobile stations 10, 12, 14, . . . , and m and the antennas 182, 184, 186, . . . , and s, from signals received from the second multi-channel receiving unit 190 and outputs the estimated channel values to the second information estimating unit 194.

In step 108, the second information estimating unit 194 combines signals received from the second multi-channel receiving unit 190 using the estimated channel values received from the second channel value estimating unit 192, estimates user information from the result of the combination, and outputs the estimated user information to an output terminal OUT2, i.e., a network. The second information estimating unit 194 performs the same operation as that of the second information estimating unit 126 shown in FIG. 5.

At least one of the second multi-channel receiving unit 190, the second channel value estimating unit 192, and the second information estimating unit 194 is enabled in response to the second control signal C2 output from the enabling unit 144 so that the second up-link data communication unit 142 performs steps 100, 102, and 108 only when it is recognized that the communication time does not belong to the random access period.

In order to perform step 104, the second enabling unit 144 outputs the first and second control signals C1 and C2 generated at a predetermined time interval, to the first and second up-link data communication units 140 and 142, respectively, and selectively operates the first and second up-link data communication units 140 and 142 individually.

By comparison of the above-described embodiments of the apparatus and method for up-link data communication according to the present invention with one another, it may be seen that the embodiment shown in FIG. 5 may be implemented at the smallest cost, the embodiment shown in FIG. 2 has the largest throughput, and the random access period is reduced identically in the three embodiments shown in FIGS. 2, 5, and 6.

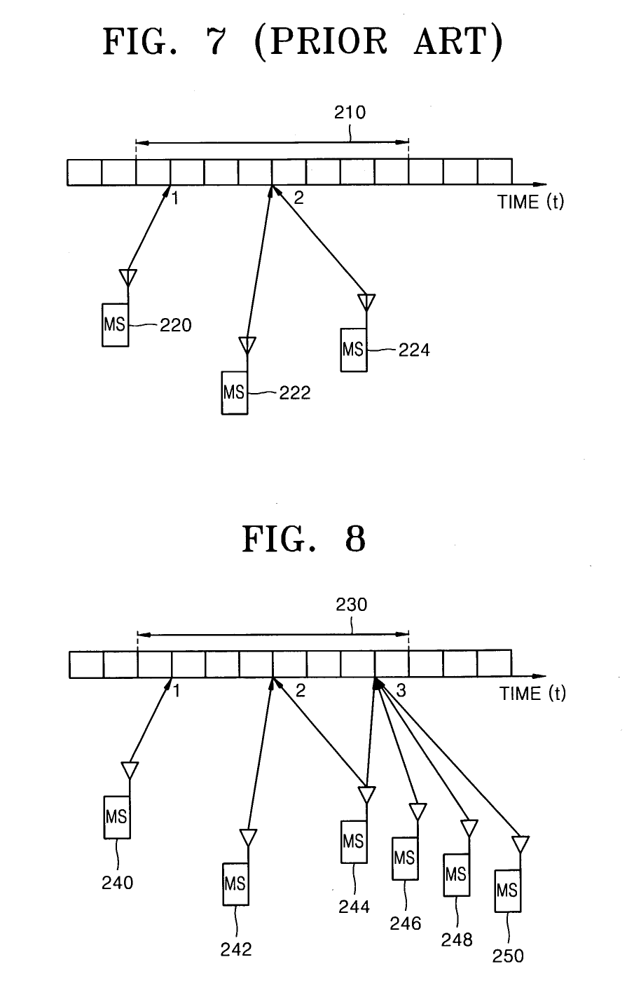

FIG. 7 illustrates the concept of random access in a conventional slotted ALOHA manner according to the prior art. Each rectangle represents a time slot as a communicable time, and boundaries between rectangles represent an instant at which communication may start.

Referring to FIG. 7, if a single mobile station (MS) 220 random-accesses a base station, as shown by the arrow at an instant 1 at which the one MS 220 begins communication, the MS 220 is able to access the base station and begin successful communication at a random access period 210. However, if two or more mobile stations (MSs) 222 and 224 simultaneously random-access the base station, as shown by the arrows at an instant 2 at which the two or more MSs 222 and 224 begin communication, the MSs 222 and 224 are not able to successfully access the base station because of collision.

FIG. 8 illustrates the concept of random access in a slotted ALOHA manner according to the present invention. Each of the rectangles represents a time slot as a communicable time, and boundaries between rectangles represent the instant at which communication may begin.

Referring to FIG. 8, if one mobile station (MS) 240 random-accesses a base station, as shown by the arrow at the instant 1 at which one MS 240 begins communication at a random access period 230, the MS 240 can successfully access the base station. Also, if two or more mobile stations (MSs) 242 and 244 simultaneously random-access a base station, as shown by the arrows at the instant 2 at which the two or more mobile stations (MSs) 242 and 244 begin communication, when the number of antennas c of the base station is greater than two (2), collision does not occur, and thus both MSs 242 and 244 are able to successfully access the base station. In this case, assuming c antennas of the base station is three (3), if four (4) mobile stations (MSs) 244, 246, 248, and 250 simultaneously random-access the base station, as shown by the arrows at the instant 3 at which the four MSs 244, 246, 248, and 250 begin communication, collision occurs, and thus the MSs 244, 246, 248, and 250 are not able to successfully access the base station. However, if the number of MSs that simultaneously access the base station is equal to or less than the number of antennas of the base station, collision is prevented, and thus the probability of successful random access is increased. Hence, the amount of resources which should be allocated for random access can be reduced such that a time excluding the random access period is increased and the capacity of a channel used to transmit user information can be increased.

Hereinafter, the method and apparatus for up-link data communication according to the present invention and a conventional method and apparatus for up-link data communication will be compared with reference to the accompanying drawings.

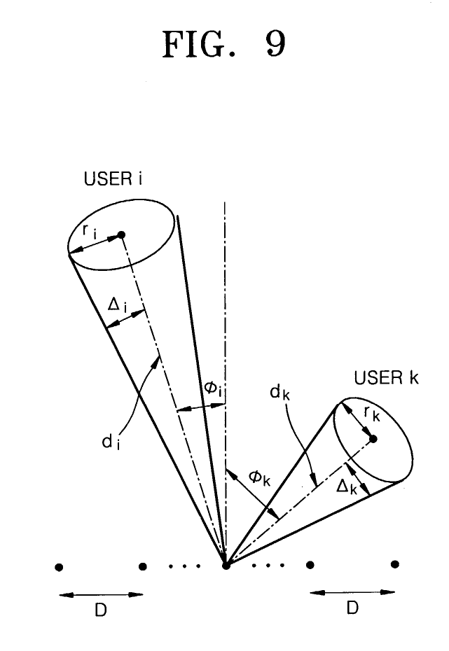

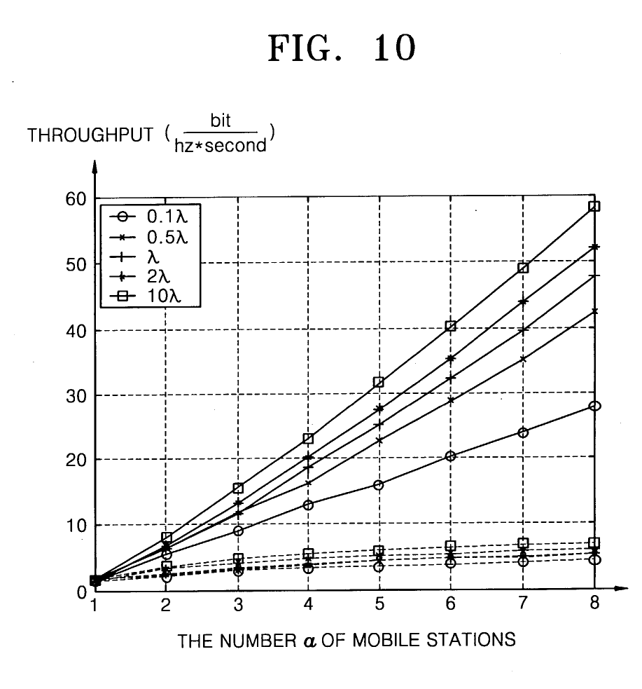

FIG. 9 is a conceptual diagram for modeling a channel H. In FIG. 9, D represents an interval between antennas of a base station, dᵢ represents a distance between an i-th (1≦i≦a) mobile station and the base station, Δᵢ represents a maximum angle in which an unequal radio wave deviates from a line connecting the mobile station to the base station, and φᵢ represents an angle formed by a line perpendicular to a line connecting antennas of the base station to one another and the line connecting the mobile station to the base station.

Assuming a radio wave is uniformly distributed within a radius rᵢ from the mobile station and a channel through which a wireless signal received from the i-th mobile station to a j-th antenna of the base station passes is hᵢⱼ, a channel Hᵢ through which the wireless signal is transmitted from the i-th mobile station to the base station is represented as a row vector according to Equation 1.

Hᵢ=[hᵢₗ . . . h^{T}ᵢₕ] (1)

The channel H through which a wireless signal is transmitted from a mobile stations 10, 12, 14, . . . , and m to the base station 40 may be expressed as a matrix according to Equation 2.

H=[H₁ . . . Hₐ]^{T} (2)

In this case, hᵢⱼ is modeled according to Equation 3.

hᵢⱼ=\sqrt{Γᵢ}aᵢⱼe^{-j2π(k-j)D/λ sin φ} ^{ᵢ} (3)

Here, aᵢⱼ represents a complex Gaussian process, λ represents a carrier frequency, and Γᵢ represents a path loss and may be modeled according to Equation 4.

$${Γ}_{i} = 20 log ( \frac{4 π f}{c} ) + α 10 log {d}_{i} + {X}_{σ} ( dB ) \qquad ( 4 )$$

Here, f represents a carrier frequency, c represents the speed of light, α represents a path loss exponent, and X₉₄ represents a fading value in a wider range having normalized log distribution. Meanings of variables f, c, α, and X₉₄ are disclosed in the book “Smart Antennas for Wireless Communications” by Theodore Rappaport, pp. 36-37.

In the above-described conditions, when the interval D between the antennas of the base station increases, a correlation is reduced. In this case, when one user having a transmission power Pᵢ communicates with the base station having c antennas, maximum ratio combining (MRC) is used in the conventional method for up-link data communication, which maximizes the throughput of the base station.

FIG. 10 is a graph for comparing the performance of the present invention with that of prior art. The horizontal axis represents the number a of mobile stations, the vertical axis represents throughput, the solid lines represent throughputs obtained by the method and apparatus for up-link data communication according to the present invention, and the dashed lines represent throughputs obtained by the conventional method and apparatus for up-link data communication using MRC.

The antenna interval D is varied to 0.1λ, 0.5λ, λ, 2λ, and 10λ, the pass loss exponent α is set to 3, normalized log fading X_{σ} is set to 0, frequency f is set to 5 GHz, radius rᵢ is set to 0.1 time of dᵢ, the position of the mobile station is uniformly distributed in a circle having a predetermined range, and in a case of no fading, the predetermined range is set to a distance in which binary phase shift keying (BPSK) having a bit error rate (BER) of 10⁻⁷ can be successfully reached.

In this case, as shown in FIG. 10, according to the present invention, when the antenna interval D increases, the correlation is reduced such that throughput, i.e., the capacity of the channel, is increased about to the number of antennas as compared to the conventional method.

As described above, in the apparatus and method for up-link data communication according to the present invention, the random access period can be reduced such that a time required for transmitting and receiving another bit of data is relatively increased and the capacity of the channel as the entire throughput is increased to the number of antennas of a base station, even if the number of antennas of each of mobile stations is only one.

Preferred embodiments of the present invention have been disclosed herein and, although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. An apparatus for up-link data communication that obtains user information from a wireless signal transmitted from b mobile stations (where b is a positive integer greater than one (1)) among a mobile stations (where a is a positive integer greater than two (2)), each mobile station having an antenna, comprising:
c antennas (where c≧a) for receiving the wireless signal;
a multi-channel receiving unit for extracting a received signal from the wireless signal received by the c antennas;
a channel value estimating unit for estimating impulse responses of channels that are formed between the mobile stations and the antennas, from the received signal and for outputting the estimated impulse responses as channel values; and
an information estimating unit for canceling interference between the mobile stations, from the received signals and the channel values, and for estimating the user information from the result of the cancellation.

2. A method for up-link data communication performed by the apparatus for up-link data communication as claimed in claim 1, comprising:
receiving the wireless signal and extracting the received signal from the received wireless signal;
estimating the impulse responses using the received signal and determining the estimated impulse responses as the channel values; and
canceling the interference using the received signal and the channel values and estimating the user information using the result of the cancellation.

3. The method for up-link data communication as claimed in claim 2, wherein canceling the interference is performed by zero forcing, minimum mean square error (MMSE), or interference cancellation.

4. An apparatus for up-link data communication that obtains user information from a wireless signal transmitted from b mobile stations (where b is a positive integer greater than one (1)) among a mobile stations (where a is a positive integer greater than two (2)), each mobile station having an antenna, comprising:
c antennas (where c≧a) for receiving the wireless signal;
a multi-channel receiving unit for extracting a received signal from the wireless signal received by the c antennas;
a channel value estimating unit for estimating impulse responses of channels that are formed between the mobile stations and the antennas, from the received signals and for outputting the estimated impulse responses as channel values;
a first information estimating unit, which is enabled in response to a first control signal, for canceling interference between the mobile stations from the received signals and the channel values, and for estimating the user information from the result of the cancellation;
a second information estimating unit, which is enabled in response to a second control signal, for combining the received signals using the channel values, and for estimating the user information from the result of the combination; and
an enabling unit for generating the first and second control signals at a predetermined time interval.

5. A method for up-link data communication performed by the apparatus for up-link data communication as claimed in claim 4, comprising:
receiving the wireless signal and extracting the received signal from the received wireless signal;
estimating the impulse responses using the received signal and determining the estimated impulse responses as the channel values;
determining whether a communication time belongs to a random access period;
canceling the interference using the received signal and the channel values and estimating the user information using the result of the cancellation, if it is determined that the communication time belongs to the random access period; and
combining the received signals using the channel values and estimating the user information using the result of the combination, if it is determined that the communication time does not belong to the random access period.

6. The method for up-link data communication as claimed in claim 5, wherein canceling the interference is performed by zero forcing, minimum mean square error (MMSE), or interference cancellation.

7. An apparatus for up-link data communication that obtains user information from a wireless signal transmitted from b mobile stations (where b is a positive integer greater than one (1)) among a mobile stations (where a is a positive integer greater than two (2)), each mobile station having an antenna, comprising:
a first up-link data communication unit, which is enabled in response to a first control signal, for estimating channel values from received signals extracted from the received wireless signal, for canceling interference between the mobile stations from the estimated channel values and the received signals, and for estimating the user information from the result of the cancellation;
a second up-link data communication unit, which is enabled in response to a second control signal, for estimating channel values from received signals extracted from the received wireless signal, for combining the received signals using the estimated channel values, and for estimating the user information from the result of the combination; and
an enabling unit for generating the first and second control signals at a predetermined time interval,
wherein each of the first and second up-link data communication units has c antennas (where c≧a) for receiving the wireless signal, and the channel values correspond to impulse responses of channels that are formed between the mobile stations and the antennas.

8. The apparatus as claimed in claim 7, wherein the first up-link data communication unit comprises:
a first multi-channel receiving unit for extracting the received signals from the wireless signal received by the c antennas;
a first channel value estimating unit for estimating the channel values from the signals received from the first multi-channel receiving unit; and
a first information estimating unit for canceling the interference from the signals received from the first multi-channel receiving unit and the channel values received from the first channel value estimating unit, and for estimating the user information from the result of the cancellation,
wherein at least one of the first multi-channel receiving unit, the first channel value estimating unit, and the first information estimating unit is enabled in response to the first control signal.

9. The apparatus as claimed in claim 7, wherein the second up-link data communication unit comprises:
a second multi-channel receiving unit for extracting the received signals from the wireless signal received by the c antennas;
a second channel value estimating unit for estimating the channel values from the signals received from the second multi-channel receiving unit; and
a second information estimating unit for combining the signals received from the second multi-channel receiving unit using the channel values received from the second channel value estimating unit, and for estimating the user information from the result of the combination,
wherein at least one of the second multi-channel receiving unit, the second channel value estimating unit, and the second information estimating unit is enabled in response to the second control signal.

10. The apparatus as claimed in claim 8, wherein the second up-link data communication unit comprises:
a second multi-channel receiving unit for extracting the received signals from the wireless signal received by the c antennas;
a second channel value estimating unit for estimating the channel values from the signals received from the second multi-channel receiving unit; and
a second information estimating unit for combining the signals received from the second multi-channel receiving unit using the channel values received from the second channel value estimating unit, and for estimating the user information from the result of the combination,
wherein at least one of the second multi-channel receiving unit, the second channel value estimating unit, and the second information estimating unit is enabled in response to the second control signal.
